(19) United States
(12) Patent Application Publication
(10) Pub. No.: US 2005/0265211 A1
(43) Pub. Date: Dec. 1, 2005

(54) Optical disk and optical disk apparatus

(75) Inventors: Hiroshi Nakane, Fukaya-shi (JP); Hiroyuki Higashino, Kawasaki-shi (JP); Takeyuki Minamimoto, Tachikawa-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 10/945,435

(22) Filed: Sep. 21, 2004

(30) Foreign Application Priority Data
May 28, 2004 (JP) 2004-159495

(51) Int. Cl. G11B 7/24

(52) U.S. Cl. 369/275.1; 369/274

(57) ABSTRACT

An optical disk is an information recording type optical disk capable of recording a visible image on one surface, and includes a disk substrate including an information recording layer in which a mark indicating information is recorded by laser beam, and a label recording region capable of recording the visible image by the laser beam and a label side information recording region which is disposed on an inner peripheral side or an outer peripheral side from the label recording region and in which a recording mark indicating printing information is recorded by laser beam are formed on the disk substrate. The visible image is additionally printed on the label recording region based on the printing information using laser beam.

### CROSS-REFERENCE TO RELATED APPLICATIONS

This application is based upon and claims the benefit of priority from prior Japanese Patent Application No. 2004-159495, filed May 28, 2004, the entire contents of which are incorporated herein by reference.

### BACKGROUND OF THE INVENTION

1. Field of the Invention

The present invention relates to an optical disk capable of recording a visible image on a label surface thereof using laser beam, and an optical disk apparatus which records the visible image on the optical disk.

2. Description of the Related Art

In recent years, as well known, optical disks such as CDs and DVDs have spread as information recording media. Examples of CDs include a read-only CD-ROM, a write-once (write-once at the same region in a disk) CD-R, a rewritable CD-RW, and examples of DVDs include a read-only DVD-ROM, a write-once DVD-R, a rewritable DVD-RAM, DVD-RW. A recording type optical disk, that is, a write-once or rewritable optical disk has an information recording layer. The recording capacity of the information recording layer is, for example, about 700 MB in the CD-R, or about 4.7 GB in DVD-R.

Characters or logos indicating the type or the like of a recording type optical disk are, for example, silk-screen printed on a label surface on a side opposite to that of an information recording layer of the disk. An optical disk including a label surface on which the characters or pictures can be recorded by an ink jet printer or handwriting has also become popular.

In recent years, documents on an optical disk and an optical disk apparatus capable of recording pictures or characters on a label surface using laser beam have been published, for example, in Jpn. Pat. Appln. KOKAI Publication No. 2002-203321.

When an optical disk printable on the label surface thereof (hereinafter the disk is referred to as a printable optical disk) is printed by a laser of an optical disk drive, information such as a printing range cannot be recorded with respect to the disk main body. That is, in the recording with respect to the label surface, information indicating whether or not additional recording is possible, or information indicating a range of a printed position cannot be recorded.

Therefore, to additionally print the printable optical disk which has been already printed, printing information at the time when a user has previously printed the disk is held beforehand for each disk in a device such as a personal computer (PC), and needs to be additionally recorded. Therefore, the same printable optical disk cannot be additionally printed among a plurality of drives (PC systems).

### BRIEF SUMMARY OF THE INVENTION

When printing is performed with respect to an optical disk printable on a label surface thereof with a laser of an optical disk apparatus, printing information is recorded in the disk, accordingly a printing range, an additionally recordable area and the like can be grasped, and additional label printing is possible in a single drive or among a plurality of drives.

In a printable optical disk according to one aspect of the present invention, printing information on a printed visible image can be recorded/reproduced using laser beam of a CD laser or the like, and it is difficult to visually identify the recorded printing information. For example, a phthalocyanine-based recording layer is formed on an inner periphery or an outer periphery of a label recording layer to perform recording/reproducing with the CD laser.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a structure of an information recording type optical disk 100a according to one embodiment of the present invention;

FIG. 2 shows a structure of an information recording type optical disk 100b according to a second embodiment of the present invention;

FIG. 3 shows a structure of an information recording type optical disk 100c according to a third embodiment of the present invention;

FIG. 4 shows light absorptance characteristics before and after recording of a CD-R disk using a phthalocyanine-based material;

FIG. 5 is a block diagram showing one embodiment of an optical disk apparatus according to the present invention; and

FIG. 6 is a flowchart showing an operation of the optical disk apparatus shown in FIG. 5 according to the present invention.

### DETAILED DESCRIPTION OF THE INVENTION

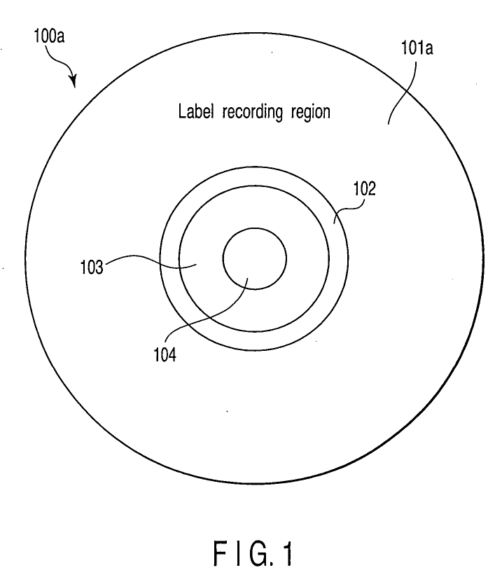

FIG. 1 shows a structure of an information recording type optical disk 100a according to one embodiment of the present invention. The optical disk 100a includes an information recording surface on one side of a disk substrate and a label surface on the other side. FIG. 1 is a diagram of the optical disk 100a viewed from the label surface.

A label recording region 101a is formed in a circle concentric with the disk 100a on the side of the label surface of the disk 100a. The label recording region 101a is a region printable using a laser of an optical disk apparatus. A label side information recording band 102 is disposed on an inner periphery from the label recording region 101a, that is, between the label recording region 101a and a clamp area 103. Printing information including a printed range of a visible image of a character or a picture printed on the label recording region 101a is recorded/reproduced with respect to the label side information recording band 102 using the laser beam. The printing information recorded in the label side information recording band 102 is difficult to visually identify. Reference numeral 104 denotes a hole for attaching the disk 100a to the apparatus.

The printed range, information (file name, date), which is a printing base, and the like are recorded in the label side information recording band 102. Accordingly, additional printing is possible among a plurality of drives/systems. When the printing information recorded in a disk is read, additional printing is easily possible not only among a plurality of drives/systems but also in a single drive/system.

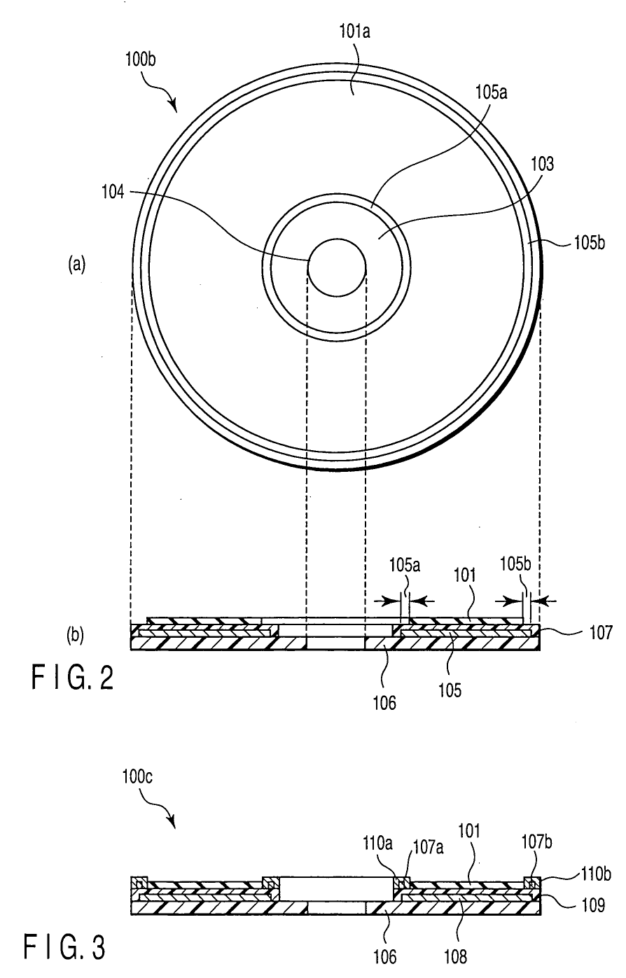

FIG. 2 is a diagram showing a structure of an information recording type optical disk 100b according to a second embodiment of the present invention, (a) of FIG. 2 is a plan view, and (b) of FIG. 2 is a sectional view.

As shown in (a) of FIG. 2, on the side of the label surface of the disk 100b, a donut-shaped label recording region 101a is disposed in a circle concentric with the disk 10b, a label side information recording band 105a is disposed on an inner peripheral side from the label recording region 101a, and a label side information recording band 105b is disposed on an outer peripheral side of the label recording region 101a.

As shown in (b) of FIG. 2, an information recording layer 105 is formed on a disk substrate 106, a protective film 107 is formed on the information recording layer 105 in such a manner as to coat the recording layer, and a label recording layer 101 is formed on the film.

The information recording layer 105 is a phthalocyanine-based recording layer, an outer diameter thereof is larger than that of the label recording layer 101, and an inner diameter thereof is smaller than that of the label recording layer 101. The protective film 107 is formed of a transparent material through which a CD laser (wavelength: 780 nm) passes. When the CD laser beam is focused on the information recording layer 105, the information can be written and read.

FIG. 3 is a sectional view showing a structure of an information recording type optical disk 100c according to a third embodiment of the present invention.

An information recording layer 108 is formed on a disk substrate 106, and a protective film 109 is formed on the information recording layer 108 in such a manner as to coat the information recording layer. A label side information recording band 107a is formed on an innermost peripheral side on the protective film 109, a label side information recording band 107b is formed on an outermost peripheral side, the label side information recording band 107a is coated with a protective film 110a, and the label side information recording band 107b is coated with a protective film 110b. A label recording layer 101 is formed on a region between the label side information recording bands 107a and 107b on the protective film 109.

The information recording layer 108 is formed of a material for use, for example, in a DVD-R, and the label side information recording bands 107a, 107b are constituted of phthalocyanine-based recording layers. The protective films 110a, 110b are formed of transparent materials through which a CD laser (wavelength: 780 nm) passes. When the CD laser is focused on the label side information recording bands 107a, 107b, the information can be written and read.

The optical disk 100c is a DVD-R in this example, but the present invention is also applicable to rewritable optical disks such as a DVD-RAM and a DVD-RW. An additionally recordable optical disk such as a DVD-R includes an information recording layer 108 including such a dyestuff that a reflectance of a laser beam applied portion permanently changes, recording marks indicating information are formed using the laser beam, and the information is recorded/reproduced. A rewritable optical disk such as a DVD-RAM or a DVD-RW includes an information recording layer 108 whose phase changes by laser beam irradiation, recording marks indicating information are formed using the laser beam, and the information is recorded/reproduced and rewritten. This also applies to a CD-R and a CD-RW.

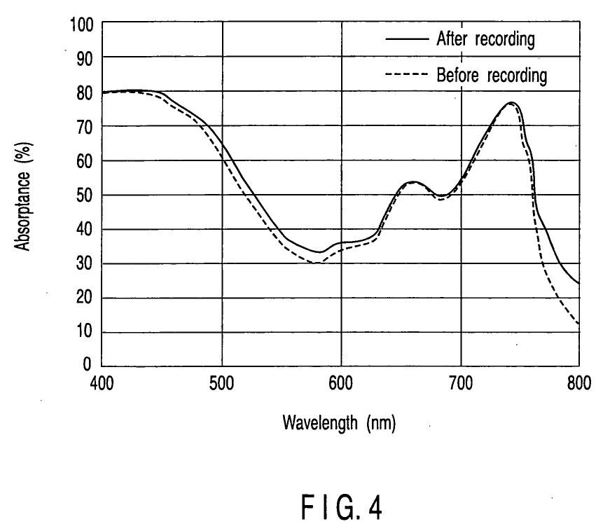

FIG. 4 shows light absorptance characteristics before and after the recording of a CD-R disk using a phthalocyanine-based material. An absorptance changes little with visible light in a range of 400 to 750 nm, and is low especially in about 600 nm, and it is therefore difficult to visually identify the information.

Next, an optical disk apparatus will be described which records/reproduces information with respect to printable optical disks, for example, the optical disks 100a to 100c and which prints a visible image on a label surface.

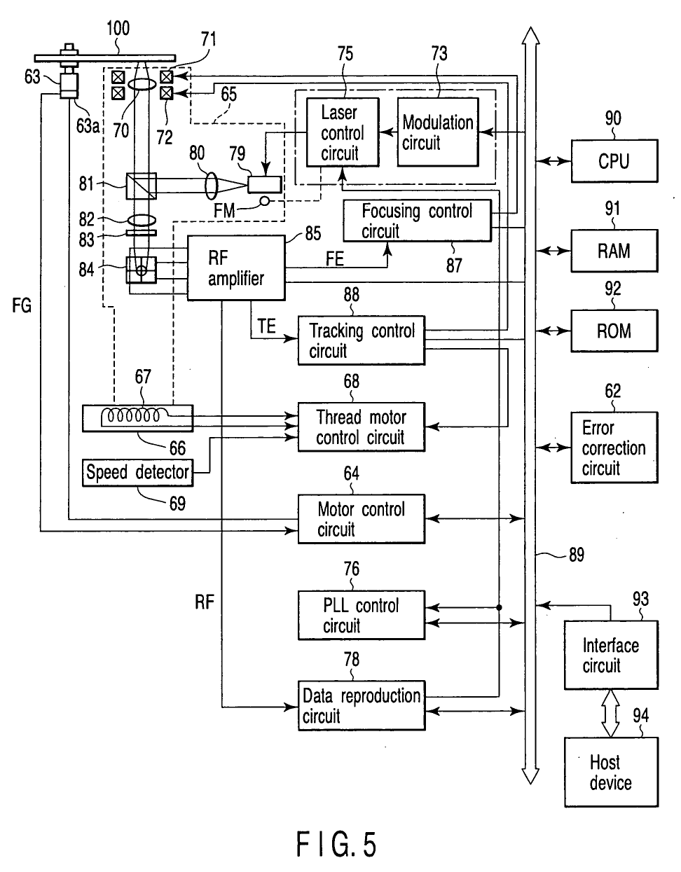

FIG. 5 is a block diagram showing a constitution of an optical disk recording/reproducing device to which one embodiment of the present invention is applied.

Land tracks and groove tracks are formed into a spiral form on the surface of the optical disk 100. The disk 100 is rotated/driven by a spindle motor 63. FG pulses are supplied from a rotation detector 63a disposed in the spindle motor 63. For example, five FG pulses are produced for every rotation of the spindle motor 63 (disk 100). A rotation angle and a rotation speed of the disk 100 can be calculated by the FG pulses.

The information is recorded/reproduced with respect to the optical disk 100 by an optical pickup head (PUH) 65. The optical pickup head 65 is connected to a thread motor 66 via a gear, and the thread motor 66 is controlled by a thread motor control circuit 68.

A speed detection circuit 69 is connected to the thread motor control circuit 68, and a speed signal of the optical pickup head 65 detected by the speed detection circuit 69 is sent to the thread motor control circuit 68. A permanent magnet (not shown) is fixed in the thread motor 66, a driving coil 67 is energized by the thread motor control circuit 68, and accordingly the optical pickup head 65 moves in a radial direction of the optical disk 100.

An objective lens 70 supported by a wire or a leaf spring (not shown) is disposed in the optical pickup head 65. The objective lens 70 is movable in a focusing direction (optical axial direction of the lens) by the driving of a driving coil 72, and is movable in a tracking direction (direction crossing an optical axis of the lens at right angles) by the driving of a driving coil 71.

A modulation circuit 73 subjects user data supplied from a host device 94 via an interface circuit 93, for example, to 8-14 modulation (EFM) to provide EFM data at the time of the recording of the information. A laser control circuit 75 supplies a writing signal to a laser diode 79 based on the EFM data supplied from the modulation circuit 73 at the time of the recording of the information (forming of a marks). The laser control circuit 75 supplies a reading signal smaller than the writing signal to the laser diode 79 at the time of the reading of the information.

A front monitor FM constituted of a photo diode detects a quantity, that is, a light emitting power of laser beam produced by the laser diode 79, and supplies a detected current to the laser control circuit 75. The laser control circuit 75 controls the laser diode 79 in such a manner as to emit the light with the laser power set by a CPU 90 for the time of the reproducing/recording, based on the detected current from the front monitor FM.

The laser diode 79 produces the laser beam in response to a signal supplied from the laser control circuit 75. The laser beam emitted from the laser diode 79 is applied onto the optical disk 100 via a collimator lens 80, a half prism 81, and the objective lens 70. Reflected light from the optical disk 100 is guided to a photo detector 84 via the objective lens 70, the half prism 81, a condenser lens 82, and a cylindrical lens 83.

The photo detector 84 is constituted of, for example, four divided photo detecting cells, and detection signals of these photo detection cells are output to an RF amplifier 85. The RF amplifier 85 processes signals from the photo detection cells to produce a focus error signal FE indicating an error from an in-focus position, a tracking error signal TE indicating an error between a center of a beam spot of laser beam and a center of the track, and an RF signal which is a total added signal of photo detection cell signals.

The focus error signal FE is supplied to a focusing control circuit 87. The focusing control circuit 87 produces a focus driving signal in response to the focus error signal FE. The focus driving signal is supplied to the driving coil 71 in the focusing direction. Accordingly, focus servo is performed in such a manner that the laser beam is constantly exactly focused on the recording film of the optical disk 100.

The tracking error signal TE is supplied to a tracking control circuit 88. The tracking control circuit 88 produces a track driving signal in response to the tracking error signal TE. The track driving signal output from the tracking control circuit 88 is supplied to the driving coil 72 in the tracking direction. Accordingly, tracking servo is performed to constantly trace the laser beam on the track formed in the optical disk 100.

When the focus servo and the tracking servo are performed, changes of the reflected light from pits or marks formed on the track of the optical disk 100 in accordance with recorded information are reflected in the total added signal RF of the output signals of the respective photo detection cells of the photo detector 84. The signal is supplied to a data reproduction circuit 78. The data reproduction circuit 78 reproduces recorded data based on a reproducing clock signal from a PLL control circuit 76.

While the objective lens 70 is controlled by the tracking control circuit 88, the thread motor 66 that is the PUH 65 is controlled by the thread motor control circuit 68 in such a manner as to position the objective lens 70 in the vicinity of a predetermined position in the PUH 65.

A motor control circuit 64, the thread motor control circuit 68, the laser control circuit 75, the PLL control circuit 76, the data reproduction circuit 78, the focusing control circuit 87, the tracking control circuit 88, an error correction circuit 62 and the like are controlled by the CPU 90 via a bus 89. The CPU 90 generally controls the recording/reproducing device in accordance with an operation command provided from the host device 94 via the interface circuit 93. The CPU 90 uses a RAM 91 as a working area, and performs a predetermined operation in accordance with control programs including a program recorded in a ROM 92 according to the present invention.

A control of focus of the laser beam with respect to the surface of the disk (label surface) having a high surface roughness according to the present invention will be described hereinafter.

Next, an operation of the optical disk apparatus according to the present invention will be described.

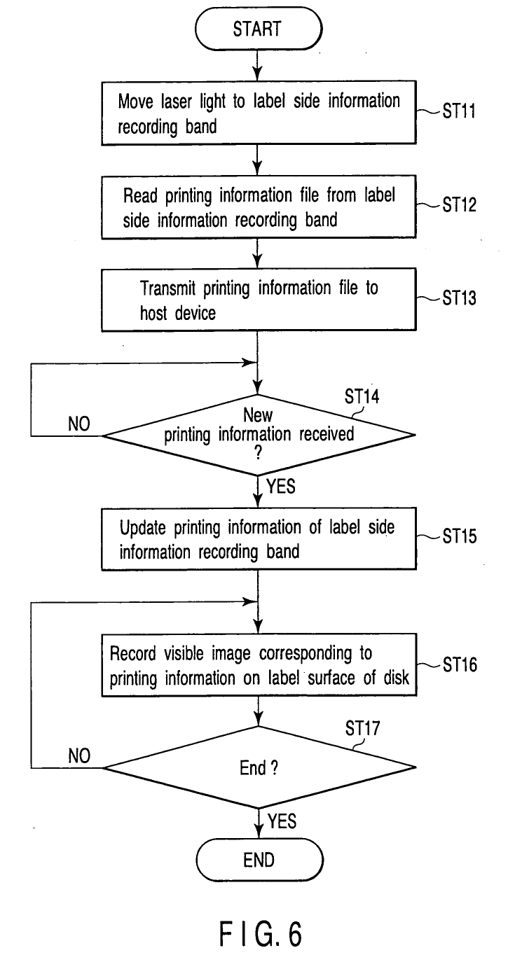

FIG. 6 is a flowchart showing an operation in which printing information is recorded in a label side information recording band during printing of a visible image on a label recording layer of a printable optical disk. Each step of the flowchart shows an operation in which the CPU 90 controls each component of the apparatus in accordance with a program stored, for example, in the ROM 92.

In the present embodiment, a case where the optical disk 100a including the label side information recording band 102 is provided at an inner peripheral side of the disk will be described as an example. The optical disk 100a with a label side thereof directed downwards (pickup 65 side) is attached to the spindle motor 63.

When an instruction for reading a printing information file is received from the host device 94 via an interface 93, the CPU 90 controls the pickup 65 to move the laser beam onto the label side information recording band 102 (ST11). The CPU 90 reads the printing information file from the label side information recording band 102 (ST12), and transmits the printing information file to the host device 94 (ST13).

The host device 94 displays contents of the received printing information file in a display section (not shown), and a user prepares new printing information based on the display. The new printing information is transmitted to the CPU 90 from the host device 94.

When new printing information is received (YES in ST14), the CPU 90 updates the printing information recorded in the label side information recording band 102 by the received printing information (ST15). Thereafter, the CPU 90 controls the pickup 65 to record a visible image corresponding to the received printing information in an empty area of the label recording region 101a (ST16, ST17).

As described above, according to the present invention, there can be provided a recording type optical disk and an optical disk apparatus capable of easily additionally printing a visible image on the label surface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An information recording type optical disk capable of recording a visible image, comprising:
a disk substrate including an information recording layer on which mark indicating information are recorded by laser beam;
a label recording region which is formed on the disk substrate and which is capable of recording the visible image by the laser beam; and
a label side information recording region which is disposed on one of an inner peripheral side and an outer peripheral side from the label recording region and on which marks indicating information are recorded by the laser beam.

2. The optical disk according to claim 1, wherein the label side information recording region comprises a phthalocyanine-based recording layer.

3. An information recording type optical disk capable of recording a visible image, comprising:
a disk substrate;
an information recording layer which is formed into a circle concentric with the disk substrate on the disk substrate and on which marks indicating information are recorded by laser beam;
a protective film formed on the information recording layer; and
a label recording layer which is formed on the protective film and which has an inner diameter larger than that of the information recording layer and an outer diameter smaller than that of the information recording layer and which is capable of recording the visible image.

4. The optical disk according to claim 3, wherein the information recording layer comprises a phthalocyanine-based recording material.

5. The optical disk according to claim 3, wherein the protective film comprises a material through which a CD laser beam passes.

6. An optical disk apparatus which records a visible image in a label recording region of a recording type optical disk comprising a label recording region capable of recording the visible image and a label side information recording region capable of recording marks indicating information on the side of a label surface of the disk, the apparatus comprising:
a pickup which produces laser beam to record the visible image in the label recording region and which is movable in a radial direction of the disk;
an input section which inputs printing information;
a recording section which controls the pickup to record the visible image corresponding to the printing information on the label recording region by the laser beam; and
a writing section which writes the printing information in the label side information recording region.
